(19) United States
(12) Patent Application Publication
(10) Pub. No.: US 2013/0221547 A1
(43) Pub. Date: Aug. 29, 2013

(54) DATA CENTER CONTAINER WITH HUMIDIFIER

(71) Applicant: XU YANG, Shenzhen City (CN)

(72) Inventor: XU YANG, Shenzhen City (CN)

(21) Appl. No.: 13/667,258

(22) Filed: Nov. 2, 2012

(30) Foreign Application Priority Data
Feb. 24, 2012 (CN) 201210043585.6

(51) Int. Cl. B01F 3/04; B65D 88/10; B65D 88/74

(52) U.S. Cl. 261/74; 220/661

(57) ABSTRACT

A data center container includes a chassis and a humidifier. The chassis includes a side plate. The side plate defines a through opening. The humidifier assembly includes a case and a humidifier. The case is secured to the side plate and covers the through opening. The humidifier is secured to the case and capable of adjusting the humidity in the chassis.

### BACKGROUND

1. Technical Field

The present disclosure relates to data center containers, more particularly to a data center with a humidifier.

2. Description of Related Art

A plurality of server computers is assembled in a data center container. In order to have the plurality of server computer working normally, a humidifier should be provided in the data center container.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a data center container in accordance with an embodiment.

FIG. 2 is an enlarged view of a circled portion II of FIG. 1.

FIG. 3 is an assembled view of the data center container of FIG. 1.

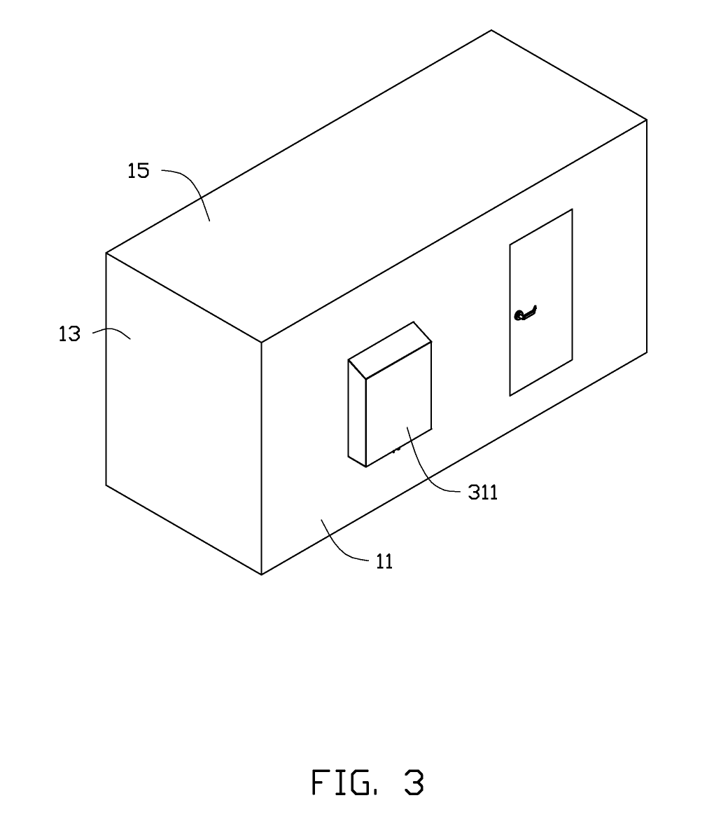

FIG. 4 is similar to FIG. 3, but shows a humidifier assembly of FIG. 2 replaced by a cover.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

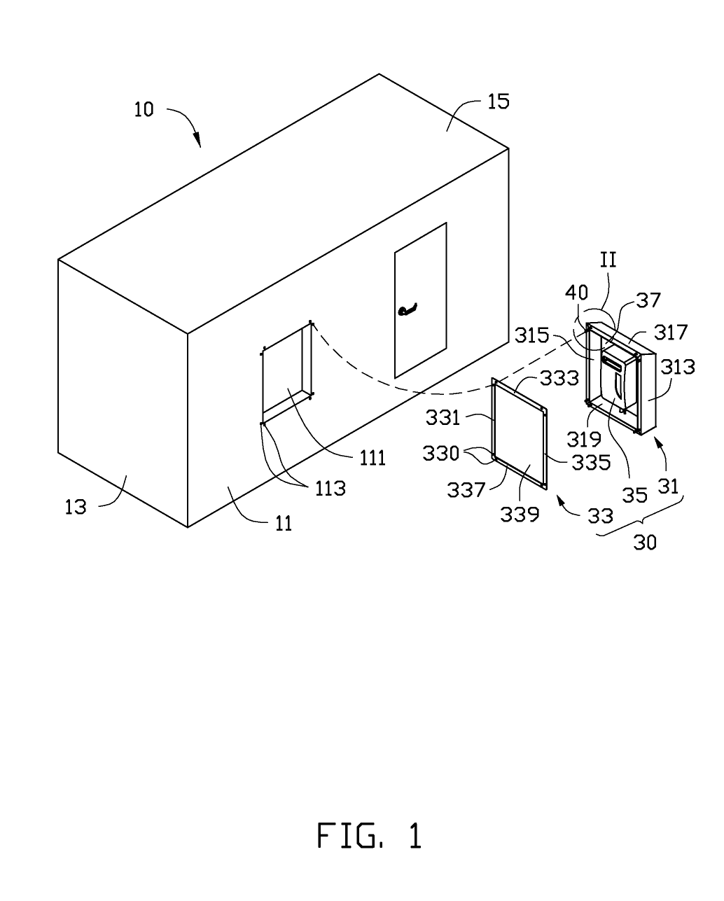

FIG. 1 illustrates a data center container of an embodiment. The data center container comprises a chassis 10 and a humidifier assembly 30. The chassis 10 is configured to receive a plurality of server computers (not shown).

The chassis 10 comprises a top plate 15, a bottom plate (not shown), two first side plates 11, and two second side plates 13. The top plate 15 may be substantially parallel to the bottom plate, the two first side plates 11 are substantially parallel to each other and perpendicular to the top plate 15, and the two second side plates 13 are substantially parallel to each other and perpendicular to the top plate 15. One of the two first side plates 11 defines a through opening 111 and a plurality of mounting holes 113 around the through opening 111. For example, the through opening 111 is rectangular, and each corner of the through opening 111 is flanked by two mounting holes 113.

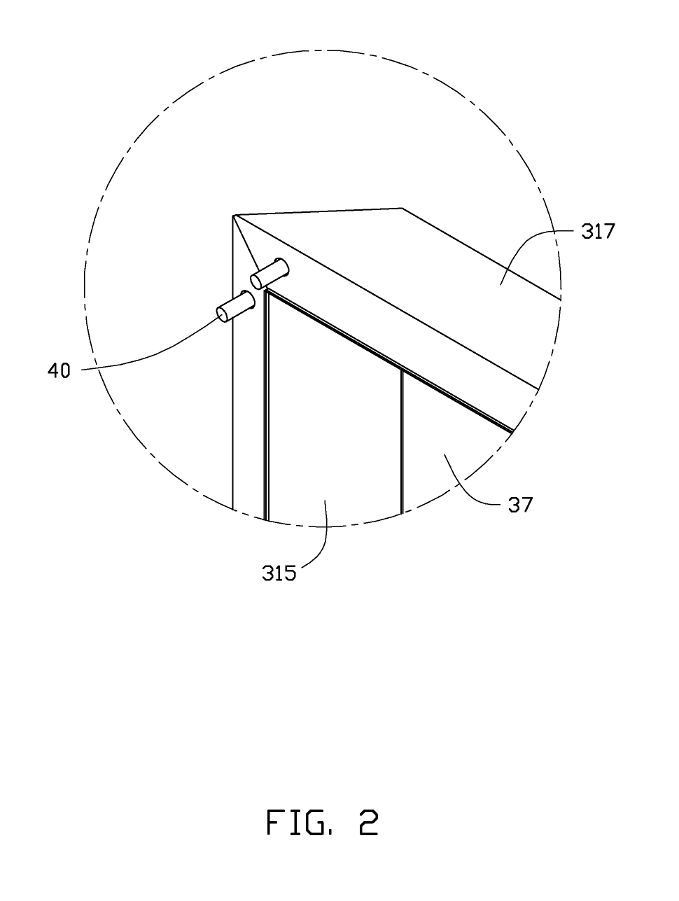

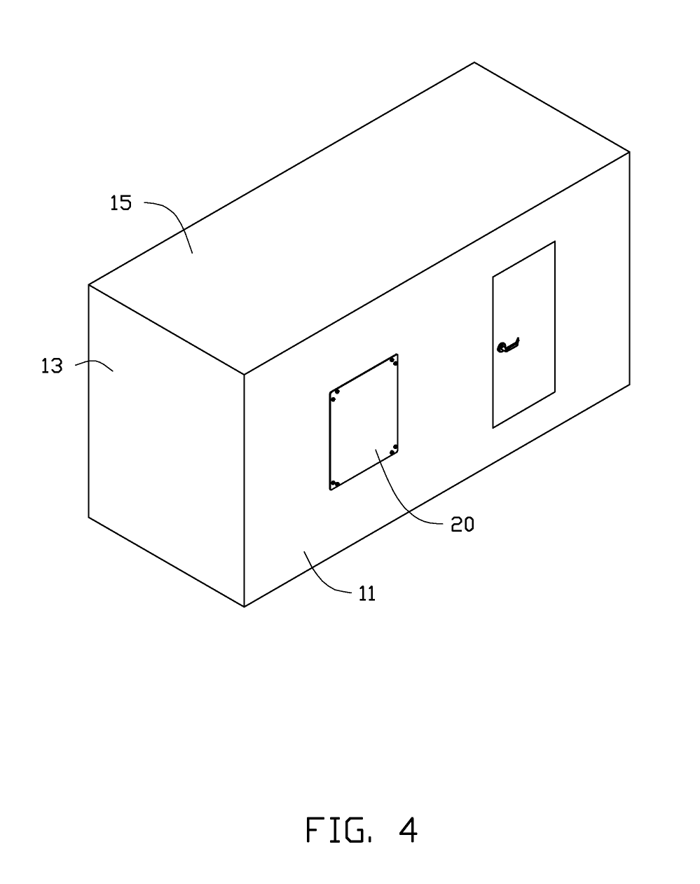

The humidifier assembly 30 comprises a case 31 and a humidifier 35. The case 31 comprises a base wall 311 (see FIG. 4), a top wall 317, a bottom wall 319, a first sidewall 313, and a second sidewall 315. The top wall 317 extends from a top edge of the base wall 311, and the bottom wall 319 extends from a bottom edge thereof. The first sidewall 313 extends from a side edge of the base wall 311, and the second sidewall 315 extends from an opposite side edge of the base wall 311. A holding space 37 is defined cooperatively by the base wall 311, the top wall 317, the bottom wall 319, the first sidewall 313, and the second sidewall 315. An obtuse angle may be defined between the top wall 317 and the base wall 311. The top wall 317, the bottom wall 319, the first sidewall 313, and the second sidewall 315 may be substantially perpendicular to the base wall 311. The holding space 37 receives the humidifier 35, which is secured to the base wall 311. A plurality of fasteners 40 (see FIG. 2) secure the top wall 317, the bottom wall 319, the first sidewall 313, and the second sidewall 315 to the chassis 10. For example, two fasteners 40 are secured to each of the bottom wall 319, the first sidewall 313, and the second sidewall 315.

Referring also to FIG. 4, the humidifier assembly 30 is secured to one of the two side plates 11 of the chassis 10. The base wall 311 of the case 31 is substantially parallel to the two side plates 11 of the chassis 10. The plurality of the fasteners 40 are secured into the plurality of the mounting holes 113. The case 31 covers the through opening 111. When the humidifier 35 is working, the humidifier 35 adjusts humidity in the chassis 10 via the through opening 111.

Referring to FIG. 1, the humidifier assembly 30 further comprises a sealing piece 33. The sealing piece 33 defines a piece opening 339 and comprises a first flange 331, a second flange 333, a third flange 335, and a fourth flange 337. The first flange 331, the second flange 333, the third flange 335, and the fourth flange 337 surround the piece opening 339. The first flange 331 is opposite to the third flange 335, and the second flange 333 is opposite to the fourth flange 337. A plurality of through holes 330 are defined in the sealing piece 33. For example, two through holes 330 are defined in the sealing piece 33 on each corner of the piece opening 339. When the humidifier assembly 30 is secured to the side plate 11 of the chassis 10, the sealing piece 33 is located between the side plate 11 and the case 31, and the plurality of the fasteners 40 are inserted through the plurality of through holes 330. Therefore, any gap between the case 31 and the side plate 11 is sealed by the sealing piece 33.

Referring to FIG. 4, the data center container further comprises a cover 20. The cover 20 defines a plurality of securing holes (not labeled). When the data center container does not require a humidifier assembly, the cover 20 is secured to the side plate 11 with a plurality of screws screwed into the plurality of securing holes and the plurality of the mounting holes 113. Therefore, the through opening 111 of the side plate 11 is shielded by the cover 20.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A data center container comprising:
a chassis, the chassis comprising a side plate, the side plate defines a through opening; and
a humidifier assembly comprising a case and a humidifier, the case secured to the side plate and covers the through opening, and the humidifier is secured to the case and capable of adjusting the humidity in the chassis.

2. The data center container of claim 1, wherein the case comprises a base wall, a top wall, a bottom wall, a first sidewall, and a second sidewall; the top wall, the bottom wall, the first sidewall, and the second sidewall extend from the base wall; the base wall, the top wall, the bottom wall, the first sidewall, and the second sidewall corporately define a holding space; and the humidifier is received in the holding space.

3. The data center container of claim 2, wherein the first sidewall is substantially parallel to the second sidewall and perpendicular to the bottom wall and the base wall, and the bottom wall is substantially perpendicular to the base wall.

4. The data center container of claim 2, wherein an obtuse angle is defined between the top wall and the base wall.

5. The data center container of claim 2, wherein the humidifier is secured to the base wall.

6. The data center container of claim 1, further comprising a sealing piece, wherein the sealing piece is secured to the side plate and located between the case and the side plate.

7. The data center container of claim 6, wherein the sealing piece defines a piece opening corresponding to the through opening of the side plate.

8. The data center container of claim 1, wherein the side plate defines a plurality of mounting holes around the through opening; and a plurality of fasteners are secured to the case and secured in the plurality of mounting hole.

9. The data center container of claim 2, wherein eight mounting holes are defined in the side plate, and each corner of the through opening is flanked by two of the eight mounting holes; two fasteners are secured to each of the top wall, the bottom wall, the first sidewall, and the second sidewall, and the two fasteners are secured in the two mounting holes on each corner of the through opening.

10. The data center container of claim 9, wherein the through opening of the side plate is rectangular.

11. The data center container of claim 2, wherein the base wall of the case is substantially parallel to the side plate.

12. A data center container comprising:
a chassis configured to receive a plurality of server computers, the chassis comprising a side plate, the side plate defining a through opening; and
a humidifier assembly comprising a case, the case configured to receive a humidifier for adjusting humidity in the chassis; wherein the case is secured to the side plate and covers the through opening.

13. The data center container of claim 12, wherein the case comprises a base wall, a top wall, a bottom wall, a first sidewall, and a second sidewall; the top wall, the bottom wall, the first sidewall, and the second sidewall extend from the base wall; the base wall, the top wall, the bottom wall, the first sidewall, and the second sidewall corporately define a holding space; and the humidifier is received in the holding space.

14. The data center container of claim 13, wherein the first sidewall is substantially parallel to the second sidewall and perpendicular to the bottom wall and the base wall, and the bottom wall is substantially perpendicular to the base wall.

15. The data center container of claim 13, wherein an obtuse angle is defined between the top wall and the base wall.

16. The data center container of claim 13, wherein the humidifier is secured to the base wall.

17. The data center container of claim 12, further comprising a sealing piece, wherein the sealing piece is secured to the side plate and located between the case and the side plate.

18. The data center container of claim 17, wherein the sealing piece defines a piece opening corresponding to the through opening of the side plate.

19. The data center container of claim 12, wherein the side plate defines a plurality of mounting hole around the through opening; and a plurality of fasteners are secured to the case and secured in the plurality of mounting hole.

20. The data center container of claim 13, wherein the base wall of the case is substantially parallel to the side plate of the chassis.
